(19) United States
(12) Patent Application Publication
(10) Pub. No.: US 2006/0164779 A1
(43) Pub. Date: Jul. 27, 2006

(54) DC motor controller safety override

(75) Inventor: Greg Alan Bengeult, Auburn, WA (US)

Correspondence Address: Anthony Claiborne, 849 136th Ave. N.E., Bellevue, WA, 98005, US

(73) Assignee: Evader, Inc., Bellevue, WA (US)

(21) Appl. No.: 11/044,249

(22) Filed: Jan. 26, 2005

(51) Int. Cl. H02H 3/00

(52) U.S. Cl. 361/100

(57) ABSTRACT

An apparatus for detecting short circuit condition in a MOSFET power transistor in a pulse width modulation controller for a commutator type direct current motor detects whether current is flowing through the channel of the transistor by monitoring current through a normally closed override means. The apparatus further monitors the control signal to the transistor gate, determining when the control signal should have cut off current through the transistor channel. An error condition is indicated when the invention detects current through the channel at a time when the control signal to the transistor gate should have cut off current through the channel. Responsive to detection of an error condition, embodiments open the override means, thereby cutting off current supplied to the motor. Embodiments further provide an alarm signal to indicate MOSFET failure.

### BACKGROUND OF THE INVENTION

1. Field of the Invention

This invention relates to systems for open loop speed control by pulse width modulation for direct current motors with commutators. More particularly, this invention relates to a safety override feature preventing dead short operation of the motor in the event of a short circuit failure in the motor controller.

2. Description of the Related Art

To vary the speed of a direct current motor with commutators, modern systems typically employ pulse width modulation. In control by pulse width modulation, a circuit between a direct current source and a direct current drain is pulsed by opening and closing at a specific frequency, controlling the variable of interest by varying the duration or width of the pulse. In the case of controllers for direct current motors with commutators, the width of the pulse at a given frequency is directly related to motor speed. The voltage across the motor is always either in a full “on” condition or a full “off” condition, with the ratio of “on” duration to “off” duration determining average motor current and, hence, motor speed. Power to the motor approaches that at dead short as the duration of the pulse or “on” condition grows broader, while power to the motor is reduced by shortening the duration of the pulse and is cut off altogether when the pulse duration is reduced to zero. In comparison with other means of varying direct current motor speed, such as resistive circuitry, pulse width modulation is a highly efficient means of control because it uses effectively all of the current from the current source for driving the motor.

Embodiments of pulse width controllers for direct current motors typically use solid state devices for providing motor drive current at variable pulse width. In such controllers, typically a network comprising a plurality of solid state devices deployed in parallel is used to accommodate the relatively large amounts of current involved in driving the motor. Earlier controllers used silicon controlled rectifiers (SCRs). Although SCR systems are fairly effective, they are expensive, heavy, bulky, inefficient, generate excessive heat, and have poor load sharing characteristics when connected in parallel to serve large loads.

A more effective method of controlling the on/off cycle of power delivered to the motor is by using a power MOSFET (metal oxide semiconductor field effect transistor) network in place of the SCRs. A power MOSFET network is preferred to SCRs because it takes up less space, is lighter, and is more energy efficient. A controller employing such a network is described in U.S. Pat. No. 4,626,750 issued to Post. Post employs a power MOSFET network as a high-speed switch to deliver power to a motor using a periodic on/off cycle generated in response to an operator input. Post inputs an operator signal to a variable resistance to generate a signal representative of desired vehicle speed, and then compares that signal to a reference signal in order to determine the on/off cycle of conduction for the power MOSFET network. For example, at full speed, the power MOSFETS will conduct 100% of the time while at half speed, the power MOSFETS will conduct at approximately a 50% duty cycle.

MOSFET based pulse width controllers have been advantageously employed in a wide range of applications to control the speed of direct current commutator motors. In particular, they are widely used to control the speed of vehicles propelled by such motors. Heretofore, however, an inherent tendency of MOSFET devices to fail has presented a serious safety risk to drivers and passengers of such vehicles.

Metal-Oxide Semiconductor Field-Effect Transistors maintain charge carriers, such as electrons, to flow along channels. An electrode called the gate, separated from channel by a thin layer of oxide insulation, controls the width of the channel, which determines how well the device conducts. The insulation keeps current from flowing between the gate and channel.

Many different conditions can cause failure of MOSFET transistors. Among such conditions are the following:
Excessive gate drive—If the MOSFET gate is driven with too high a voltage, then the gate oxide insulation can be punctured rendering the device useless.
Insufficient gate drive (incomplete turn on)—MOSFET devices are generally capable of switching large amounts of power because they are designed to dissipate minimal power when they are turned on. If the device is not fully turned on, the device will have a high resistance during conduction and will dissipate considerable power as heat.
Over-voltage—MOSFETs have very little tolerance to overvoltage through the channel. Damage to devices may result if the voltage rating is exceeded for as little as a few nanoseconds. MOSFET devices should be rated conservatively for the anticipated voltage levels, and careful attention should be paid to suppressing any voltage spikes or ringing.
Prolonged current overload—High average current causes considerable thermal dissipation in MOSFET devices due to the relatively high on-resistance. If the current is very high and heatsinking is poor, then the device can be destroyed by excessive temperature rise. In high current motor controllers, MOSFET devices are typically paralleled directly to share high load currents.
Transient current overload—Short duration, massive current overload can cause progressive damage to the device with little noticeable temperature rise prior to failure.
Shoot-through (cross conduction)—If the control signals to two opposing MOSFETs in a network overlap, then a situation can occur where both MOSFETs are switched on together. This can result in very short but intense current pulses through both switching devices.

Whatever the cause of failure, the typical result is that the channel of the MOSFET device short-circuits rather than burning open-circuit. When failure resulting in short-circuit happens, the current supplied by the motor controller is no longer pulsed, but rather is constantly provided in a full “on” condition, with the result that the motor is operated with maximum power regardless of operator signal. In a vehicle powered to high speeds by a direct current motor, the possibility of MOSFET failure resulting in vehicle operation at uncontrolled maximum speed presents an obvious safety risk.

In the prior art, a number of approaches have been taken to safeguard motor operation in the event of MOSFET failure in the motor controller. In U.S. Pat. No. 4,910,447 to Masters, a controller is described for rectifying an A.C. power supply to drive a D.C. motor with pulse width modulation. In Masters' controller, circuitry is provided to reduce or cut the speed of the motor responsive to detecting that the speed of the motor is out of control of the controller. Masters thereby indirectly provides a safeguard for motor operation in the event of a short circuit of the MOSFET in the controller. Masters' controller, however, is dependent upon circuitry providing a motor speed reference signal, adding to the cost and complexity of his controller. Furthermore, Masters' controller is inappropriate for controlling a motor driving a vehicle, which may often in fact be operating at a speed differing from the speed indicated by the controller, as when the operator of the vehicle reduces throttle to cause the vehicle to decelerate against forward momentum.

In U.S. Pat. No. 5,991,505 to Frank, a motor controller is described wherein a microprocessor within the controller is adapted to detect fault in the controller's power transistor and, responsive to detection of fault, to disconnect power to the motor via relay. While such a means of fault detection and safety override may be effective in preventing operation of the motor at a dead short in the event of MOSFET failure, microprocessor control is itself error-prone, requiring closely controlled tolerances in operating temperatures, transient voltages, static electricity, and other environmental and operational parameters. Furthermore, microprocessor based solutions such as Frank's require costly components.

What is needed is a cost effective means of directly, rapidly and reliably detecting MOSFET failure in pulse width modulation motor controllers and, responsive to such detection, providing a safety override of current supplied to the motor.

### BRIEF DESCRIPTION OF THE INVENTION

The present invention is an apparatus for detecting short circuit condition in MOSFET power transistors in pulse width modulation controllers for commutator type direct current motors. Amplifying voltage drop across the channel of the MOSFET transistor, the present invention provides circuitry to detect whether current is flowing through the channel of the transistor. Circuitry is further provided for monitoring the control signal to the transistor gate, indicating when the control signal should have cut off current through the transistor channel. An error condition is indicated when the invention detects current through the channel at a time when the control signal to the transistor gate should have cut off current through the channel. Responsive to detection of an error condition, the present invention provides a signal to indicate MOSFET failure and to cut off current supplied to the motor.

### BRIEF DESCRIPTION OF THE DRAWINGS

Other objects, advantages, features and characteristics of the present invention, as well as methods, operation and function of related elements of structure, and the combination of parts and economies of deployment, will become apparent upon consideration of the following description and claims with reference to the accompanying drawings, all of which form a part of this specification, wherein:

FIG. 1 is a simplified circuit diagram illustrating pulse width modulation employing a MOSFET transistor in a motor controller according to the present invention;

FIG. 2 is simplified circuit diagram illustrating a motor controller safety override means in an embodiment of the present invention;

FIG. 3 is a timing diagram for a MOSFET transistor;

FIG. 4 is a flow chart illustrating monitoring and safety override functionalities of the present invention; and

FIG. 5 is a circuit diagram for an embodiment of the present invention.

### DETAILED DESCRIPTION OF THE PREFERRED EMBODIMENTS

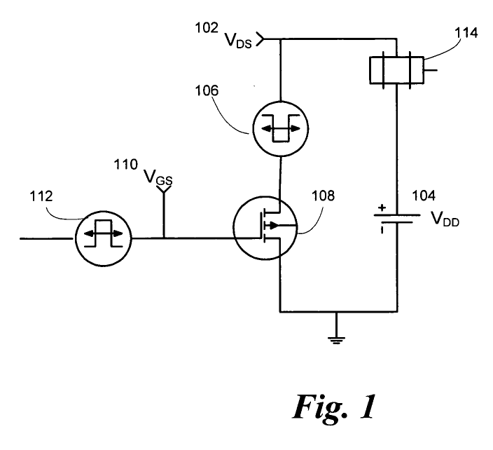

FIG. 1 illustrates a simplified circuit diagram for a pulse width modulation MOSFET switched motor controller circuit according to the present invention. Voltage between a direct current power source 102 and a direct current power drain 104 (such as may be supplied by a battery as illustrated) is switched on and off in a pulse width modulated fashion 106 by MOSFET transistor 108 in response to gate voltage 110 supplied to MOSFET transistor 108 in pulse width modulated form 112. In vehicle applications, pulse width gate signal 112 is normally modulated in response to a throttle signal indicating desired motor speed, typically from the vehicle's operator. The circuitry for generating pulse width modulated gate signal 112 is not illustrated because any number of means of generating such a pulse width modulated gate signal are well known to those of skill in the art. The present invention encompasses all such means. In any case, pulse width modulated power 106 is supplied to direct current commutator motor 114, whose speed is proportional to the width of the pulse 106 supplied through MOSFET transistor 108.

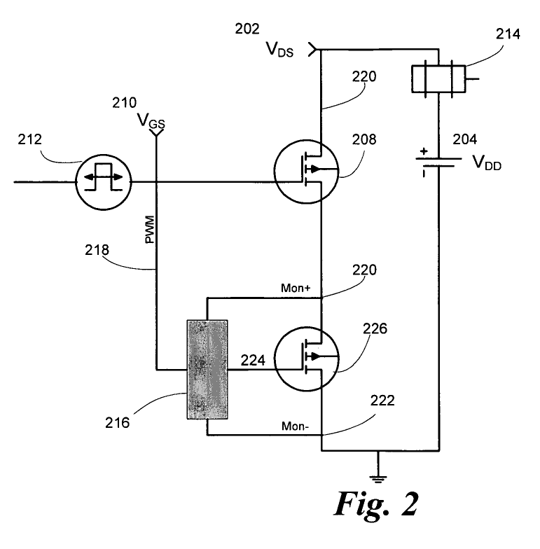

Turning now to FIG. 2, the safety override functionality is illustrated in simplified form. As in FIG. 1, voltage between a direct current source 202 and a direct current drain 204 is switched by a switching MOSFET transistor 208 in a pulse width modulated fashion in response to gate voltage 210 supplied in pulse width modulated form 212, to drive motor 214 at a speed proportional to the width of the pulse supplied through switching MOSFET transistor 208. In the present invention, monitoring and override circuitry 216 monitors current through the channel of MOSFET override transistor 226 by comparing voltage between the positive side 220 of the channel and the negative side 222 of the channel. Because MOSFET override transistor 226 has a small resistance even when conducting, the presence of voltage between the two sides of the channel, 220, 222, indicates that current is flowing through MOSFET switching transistor 208 to motor 214. Advantageously, circuitry 216 further monitors pulse width modulated voltage 218 supplied to the gate of switching MOSFET transistor 208.

An error condition is indicated when current flow is detected through channel 220, 222, at a time that pulse width modulated signal 218 to the gate of switching MOSFET transistor 208 should have caused MOSFET 208 to be shut off. Circuitry 216 normally sends a gate signal 224 to MOSFET override transistor 226, causing override transistor 226 to conduct current through its channel to supply current through switching MOSFET transistor 208 to motor 214. In the event an error condition is indicated as described above, however, circuitry 216 cuts gate voltage 224 to MOSFET override transistor 226, thereby causing the channel of override transistor 226 to open, cutting power to motor 214 through MOSFET transistor 208, which circuitry 216 has detected to be defectively short-circuited.

As will be clear to those of skill in the art, other embodiments may be made in keeping with the spirit of the present invention. For example, instead of MOSFET override transistor 226, an effective safety override may employ a normally closed electromechanical relay that opens current supplied to the channel of switching MOSFET transistor 208 in response to an error indication by circuitry 216. Further, as will be clear to those of skill in the art, embodiments of the invention may employ any number of means of detecting current through the channel 220, 222 of MOSFET override transistor 226. The present invention merely requires that circuitry 216 monitor pulse width modulated signal 218 to the gate of switching MOSFET transistor 208 while monitoring current through the transistor's channel, indicating an error condition at any time that current is flowing through the channel of transistor 208 when the gate signal 218 has indicated that the current should be shut off.

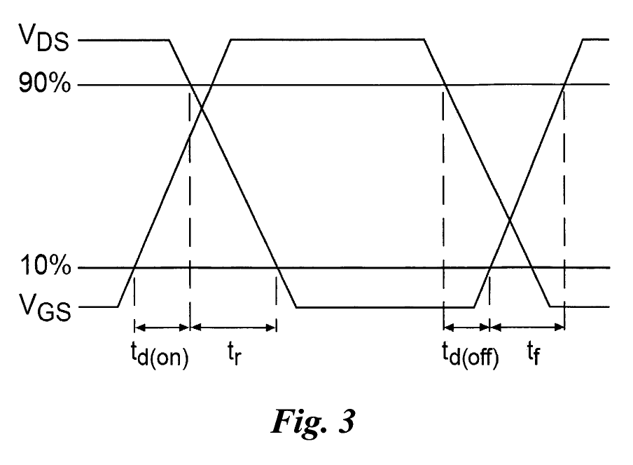

Concerning timing, the channel of a switching MOSFET transistor in its normal condition does not immediately become conductive when gate voltage is supplied to it. Referring now to FIG. 3, illustrated are timing considerations relevant to switching MOSFET transistors. As gate voltage V_{GS} is increased above a turn-on threshold value, the voltage V_{DS} across the transistor's channel begins to drop, indicating the channel is becoming conductive. There is a delay, referred to as the turn-on delay time, t_{d(on)}, between the time gate voltage reaches the threshold value and when the channel begins to become conductive. There is a further delay, referred to as the rise time, tᵣ, between when the channel begins to become conductive and when it becomes substantially conductive.

Similarly, the conducting channel of a switching MOSFET transistor does not immediately become open when voltage is removed from the transistor gate. As gate voltage V_{GS} is decreased below a turn-off threshold value, the voltage V_{DS} across the transistor's channel begins to rise, indicating the channel is becoming non-conductive or open. There is a delay, referred to as the turn-off delay time, t_{d(off)}, between the time gate voltage drops below the threshold value and when the channel begins to become open. There is a further delay, referred to as the fall time, t_{f}, between when the channel begins to open and when it becomes substantially open.

The present invention detects error condition in the switching MOSFET transistor when it determines that the gate voltage is below the turn-on threshold voltage for the transistor and current is flowing through the transistor. Such a condition would indicate the channel is substantially open even though gate voltage has been removed.

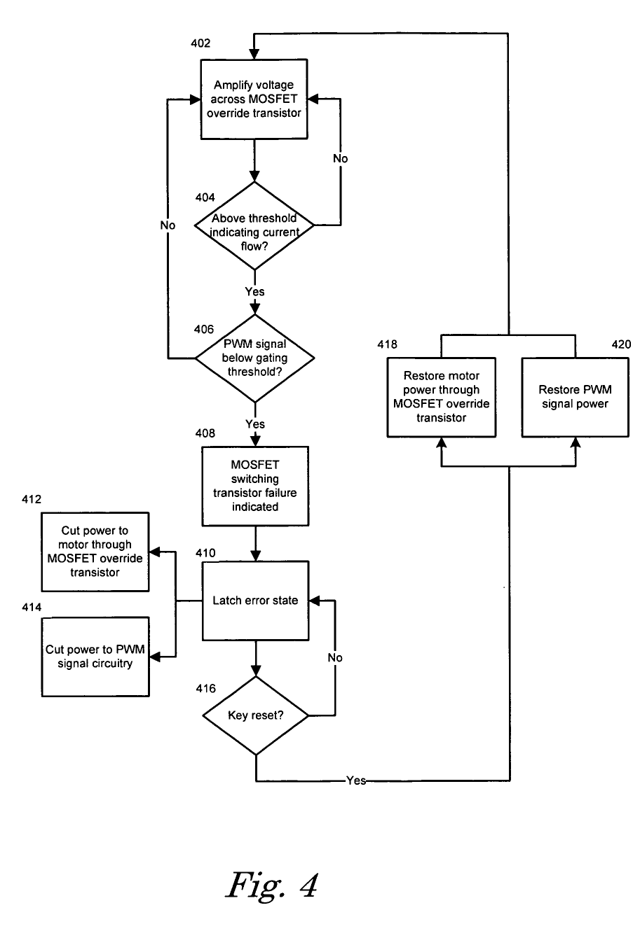

Turning now to FIG. 4, a flow chart for an embodiment of the invention is depicted. Voltage across the MOSFET override transistor is amplified 402 and compared 404 to a threshold voltage. If the amplified voltage across the override transistor is determined to exceed a threshold indicating current flow when the pulse width modulated signal to the MOSFET switching transistor is determined 406 to be below the gating threshold for the switching transistor, then a failure condition is indicated 408 for the MOSFET switching transistor. The error state is latched 410 and current is cut 412 to the motor, in some embodiments (such as that depicted in FIG. 2) by dropping gate voltage to the MOSFET override transistor, causing it to switch off current through the motor circuit. In some embodiments, an error condition causes power to be cut off 414 to the pulse width modulation signal circuitry as well. The error state remains latched 410 until key reset 416 restores power. If, after reset, a failure is again indicated 408, the error state will again be latched 410.

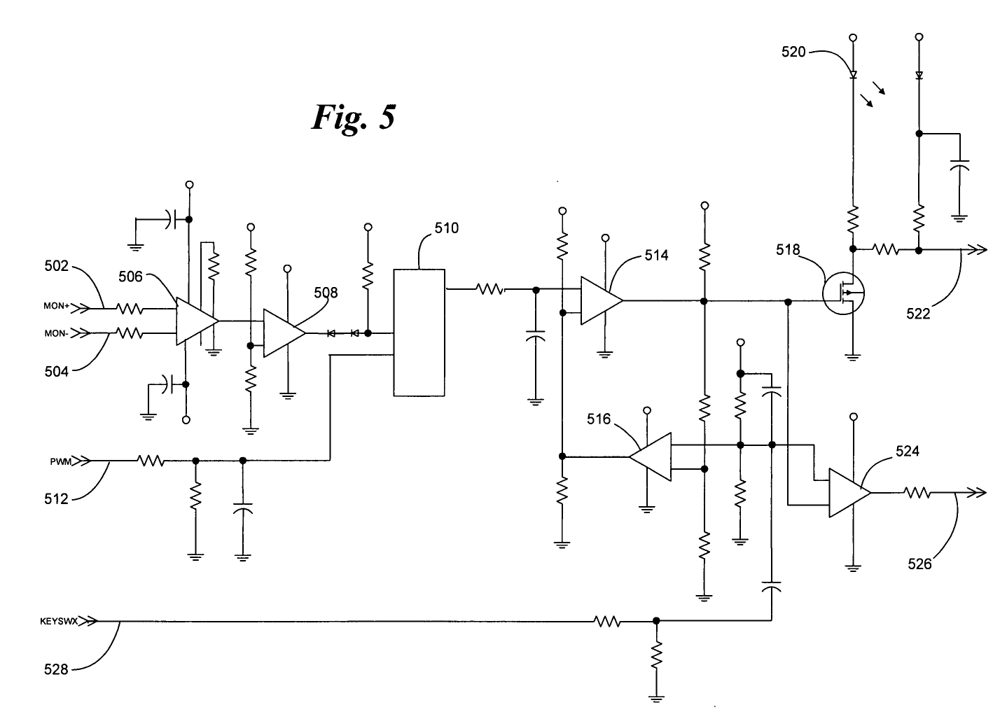

Turning now to FIG. 5, a circuit diagram for the present invention is illustrated. Current supplied to the D.C. motor is detected by monitoring voltage between the positive side 502 of the channel of the MOSFET override transistor (not shown) and the negative side 504 of the channel of the override transistor. In the depicted embodiment, this voltage difference is amplified by differential amplifier 506 and monitored by comparator 508, which is triggered when the voltage difference between the positive side 502 and the negative side 504 of the channel is above a threshold voltage determined to be consistent with current flow to the motor. Output from comparator 508 indicates sensed voltage, which is sampled by sample and hold circuit 510 (such as the monolithic sample and hold circuit LF398M from National Semiconductor Corporation of Santa Clara, Calif.) when the signal 512 from the pulse width modulation circuit indicates that there should be no current to the motor. Sensed voltage at such a time indicates short circuit such as occurs on failure of the MOSFET switching transistor.

On error detection, low-pass filtered output from sample and hold circuit 510 passes through back-to-back comparators 514, 516, which provide hysteresis and latch the error signal from sample and hold circuit 510. MOSFET transistor 518 is normally off, thereby allowing gate voltage 522 to turn the MOSFET override transistor on. In an error condition, gate voltage is supplied to transistor 518, turning it on, illuminating LED 520, and removing gate voltage 522 from the MOSFET override transistor, thereby cutting current through the defective switching transistor to the motor. In some embodiments, on error the power is cut to the pulse width modulation circuitry as well. In the depicted embodiment, this function is provided by comparator 524, which cuts supply voltage 526 to the pulse width modulation circuitry on error. In some embodiments as well, the error state that is latched by comparators 514, 516 may be reset by voltage 528 provided to comparators 514, 516 via manual key switch.

As will be clear to those of skill in the art, the present invention is not limited to the depicted embodiment. What is required is that a normally closed override means be provided, which could be the depicted MOSFET override transistor, but could also be a normally closed electromechanical relay, as discussed earlier in reference to FIG. 3, or any other electrically switched normally closed circuit path.

The present invention further requires that there be a small but sufficient resistance across the normally closed circuit path of the override means so that a measurable voltage may be detected across the circuit path when current is conducted in the main circuit through the override means to the motor. As will be clear to those of skill in the art, any number of means may be employed to detect whether there is voltage above a threshold level across the override means circuit path. While a differential amplifier and comparator are described for amplifying and monitoring voltage across the override means circuit path in reference to the depicted embodiment, other means, such as an appropriately configured N-channel field-effect transistor (FET), may be employed for such purpose. All means for detecting that the voltage across the override means circuit path exceeds a threshold value, indicating that the main circuit is conducting current, are within the scope of the present invention.

The invention determines that an error condition exists in the MOSFET switching transistor when voltage is detected across the override means circuit path at a time that the gate voltage to the switching transistor should have cut off the switching transistor and thereby cut of voltage to the main circuit. While the depicted embodiment performs such operation via use of a sample and hold circuit, as will be clear to those of skill in the art, other embodiments may perform the same function in a different manner. For example, other embodiments may simply invert the output of an additional MOSFET monitoring transistor, substantially identical to the MOSFET switching transistor in switching time characteristics, which is gated with the same signal as that provided to the MOSFET switching transistor. In such embodiments, the inverted output of the MOSFET monitoring transistor should be high when the MOSFET switching transistor should be off. In keeping with the spirit of the present invention, when such output is determined by gate logic to be high at the same time that voltage is detected across the override means circuit path, an error condition is indicated. All means of determining when the MOSFET switching transistor should be off, and determining that an error condition exists when there is voltage across the override means circuit path at such time, are within the scope of the present invention.

Elaborations upon this invention may, as depicted in the foregoing embodiment, further present a visible error indication such as an illuminated LED. In the alternative or in addition, the invention may create an audible error indication, such as an audible alarm, to warn of an error condition.

While, as described, some embodiments of the present invention cut off power to the main circuit when an error condition is detected, yet other embodiments of the present invention may implement a “fail-safe” functionality, so that, when the invention determines that a MOSFET switching transistor has failed, the defective transistor is no longer used for switching the main circuit and an alternative transistor is used instead.

Although the detailed descriptions above contain many specifics, these should not be construed as limiting the scope of the invention but as merely providing illustrations of some of the presently preferred embodiments of this invention. Various other embodiments and ramifications are possible within its scope, a number of which are discussed in general terms above. It is intended that the scope of the present invention encompass all means known to those of skill in the electronics arts to provide a safety override functionality to MOSFET switched pulse code modulated commutator motor controllers as generally described in the foregoing.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

I claim:

1. A safety apparatus for a MOSFET-switched, pulse width modulated controller for a direct current motor, comprising:
an override means having a circuit path that is normally closed in the motor circuit;
a means for detecting current through the override means; and
a means for determining when the MOSFET switch should be off,
whereby an error condition is determined to exist when current is detected through the override means at a time it is determined that the MOSFET switch should be off.

2. A safety apparatus according to claim 1, further comprising a means for opening the override means when an error condition is determined to exist, thereby cutting off current to the motor.

3. A safety apparatus according to claim 1, wherein the means for detecting current through the override means comprises a means for detecting voltage above a pre-established threshold across the normally closed override means circuit path.

4. A safety apparatus according to claim 1, wherein the override means is a MOSFET transistor.

5. A safety apparatus according to claim 1, wherein the override means is an electro-mechanical relay.

6. A safety apparatus according to claim 1, further comprising an alarm indicator when an error condition is determined to exist.

7. An apparatus for detecting failure in a MOSFET switching transistor in a pulse width modulated controller for a direct current motor, comprising:
an override means having a circuit path that is normally closed in the motor circuit;
a means for detecting current through the override means;
a means for monitoring gate voltage to the MOSFET switching transistor and determining when the MOSFET switching transistor should not conduct current,
whereby failure is detected in the MOSFET switching transistor when current is detected through the override means when the MOSFET switching transistor should not conduct current.

8. An apparatus for detecting failure according to claim 7, wherein the means for monitoring gate voltage to the MOSFET switching transistor and determining when the MOSFET switching transistor should not conduct current comprises a sample and hold circuit.

9. An apparatus for detecting failure according to claim 7, wherein the means for monitoring gate voltage to the MOSFET switching transistor and determining when the MOSFET switching transistor should not conduct current comprises a MOSFET monitoring transistor.

10. In a circuit for a direct current motor having a normally closed override means, the motor speed regulated by a pulse width modulated controller having a MOSFET switching transistor, a method for detecting failure in the MOSFET switching transistor comprising determining whether there is current passing through the override means when the MOSFET transistor should not be conducting current.
